(19) United States
(12) Patent Application Publication
(10) Pub. No.: US 2002/0071150 A1
(43) Pub. Date: Jun. 13, 2002

(54) Apparatus and method for controlling routing

(76) Inventors: Yuji Nomura, Kawasaki (JP); Akira Chugo, Kawasaki (JP); Jun Ogawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/988,968

(22) Filed: Nov. 20, 2001

(30) Foreign Application Priority Data
Dec. 8, 2000 (JP) 2000-373731

(51) Int. Cl. H04B 10/08; H04B 10/20; H04J 14/00

(52) U.S. Cl. 359/118; 359/110

(57) ABSTRACT

An apparatus and method for controlling routing that make effective use of wavelengths for efficient network operation. A state information obtaining section obtains state information regarding a network. An optical edge node specifying section specifies an egress optical edge node located on the output side of an optical network and an ingress optical edge node located on the input side of the optical network to establish an optical path to a destination address. A routing section explicitly sets routes according to destinations to the ingress optical edge node in a network connected to the input side of the optical network.

### BACKGROUND OF THE INVENTION

(1) Field of the Invention

This invention relates to an apparatus and method for controlling routing and, more particularly, to a routing control apparatus for controlling routing in a network including an optical network and routing control method for controlling routing.

(2) Description of the Related Art

Various communication network services are needed and communication networks for providing these services have become complex and extremely large. Conventionally, networks have been built locally. However, with the spread of network equipment, such as a router and gateway, recent communication networks can combine with one another, resulting in a sharp increase in composite networks.

An example of a composite network is as follows. Networks at both ends (edge networks) consist of an IP node network, label switch node network, or the like and a network at the center (core network) consists of an optical network.

FIG. 7 is a view showing the structure of a composite network. A composite network 100 comprises IP router networks 101 and 102 and an optical network 103. The IP router network 101 and the optical network 103 connect via ingress optical edge nodes 103a through 103c (collectively referred to as an ingress optical edge node 103-1). Furthermore, the IP router network 102 and the optical network 103 connect via egress optical edge nodes 103d through 103f (collectively referred to as an egress optical edge node 103-2). The IP router network 101 includes IP routers 101a through 101d and the IP router network 102 includes IP routers 102a through 102d. An optical edge node is a node that communicates with any optical edge node at the optical level via an optical cross connector etc.

In this composite network 100, the optical network 103 automatically assigns a wavelength used for communication between the ingress optical edge node 103-1 and egress optical edge node 103-2 according to how the composite network 100 is used.

This will establish an optical path along which communication between the ingress optical edge node 103-1 and egress optical edge node 103-2 is performed. The operation of establishing an optical path is performed only in the optical network 103. That is to say, the optical network 103 does not cooperate with the IP router network 101 or 102, being an edge network, to perform this operation.

The ingress optical edge node 103-1 and egress optical edge node 103-2 in the optical network 103 can be connected by one hop. Therefore, when a packet with an IP header or label is input to the ingress optical edge node 103-1, the shortest optical path for the packet will be selected there and be transferred along an optical path which realizes the shortest connection.

As a result, connectivity will be ensured between the ingress optical edge node 103-1 and egress optical edge node 103-2 in the optical network 103 and, as shown in FIG. 7, there will be full mesh topology (in this example, the number of paths is 3×3=9) in the optical network 103.

For example, it is assumed that a technique for assigning automatically a label by which connection between nodes can be identified, like the one used in multi-protocol label switching (MPLS), is applied to the optical network 103. In this case, when an entry for a new destination is added in the ingress optical edge node 103-1, an optical label (wavelength) path to that entry will be set.

By doing so, optical label paths which connect all of the ingress optical edge node 103-1 and all of the egress optical edge node 103-2 will be set.

With the IP or label switching technique, IP headers or labels can be widely used, so users have been able to use them without the consciousness of their being limited network resources. With an optical network using, for example, wavelength division multiplex (WDM), however, it is necessary for the following reasons to minimize the number of wavelengths (the number of optical paths) used.

(1) The number of wavelengths which can be used on one fiber is limited, so they need to be used effectively.

(2) An increase in the number of fibers enables to increase the number of wavelengths. However, an increase in the number of fibers results in a high cost.

(3) An increase in the number of wavelengths leads to an increase in the number of sending and receiving devices, resulting in expensive nodes.

In other words, with the conventional method for setting an optical path adopted in the above composite network 100, there arises full mesh connection between the ingress optical edge nodes and egress optical edge nodes. This makes it impossible to use wavelengths effectively, resulting in inefficient network operation.

### SUMMARY OF THE INVENTION

An object of the present invention is to provide a routing control apparatus for realizing efficient network operation.

Another object of the present invention is to provide a routing control method for realizing efficient network operation.

In order to achieve the above first object, a routing control apparatus for controlling routing in a network including an optical network is provided. This routing control apparatus comprises state information obtaining means for obtaining state information regarding the network, optical edge node specifying means for specifying an egress optical edge node located on the output side of the optical network and an ingress optical edge node located on the input side of the optical network to establish an optical path to a destination address, and routing means for setting explicitly routes according to destinations to the ingress optical edge node in a network connected to the input side of the optical network.

Furthermore, in order to achieve the above second object, a routing control method for controlling routing is provided. This routing control method comprises the step of obtaining state information regarding a network, the step of specifying an egress edge node located on the output side of a core network and an ingress edge node located on the input side of the core network to establish a path to a destination address, and the step of setting explicitly routes according to destinations to the ingress edge node in an edge network connected to the input side of the core network.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for describing the principles underlying a routing control apparatus according to the present invention.

FIG. 2 is a view showing the structure of a first embodiment.

FIG. 3 is a view showing the structure of a second embodiment.

FIG. 4 is a view showing the structure of a third embodiment.

FIG. 5 is a view showing the structure of a fourth embodiment.

FIG. 6 is a flow chart showing a routing control method according to the present invention.

FIG. 7 is a view showing the structure of a composite network.

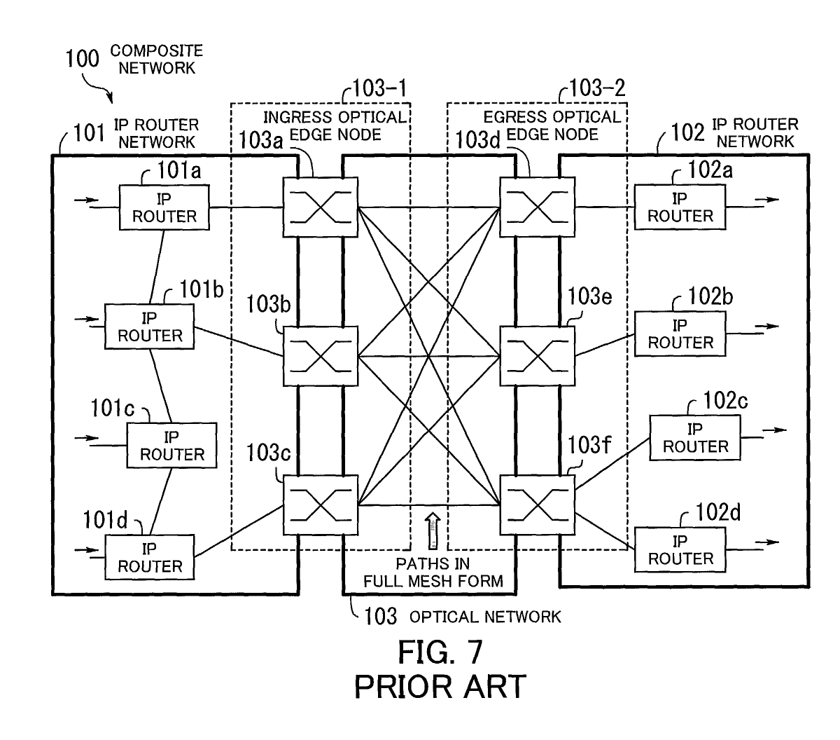

### DESCRIPTION OF THE PREFERRED EMBODIMENTS

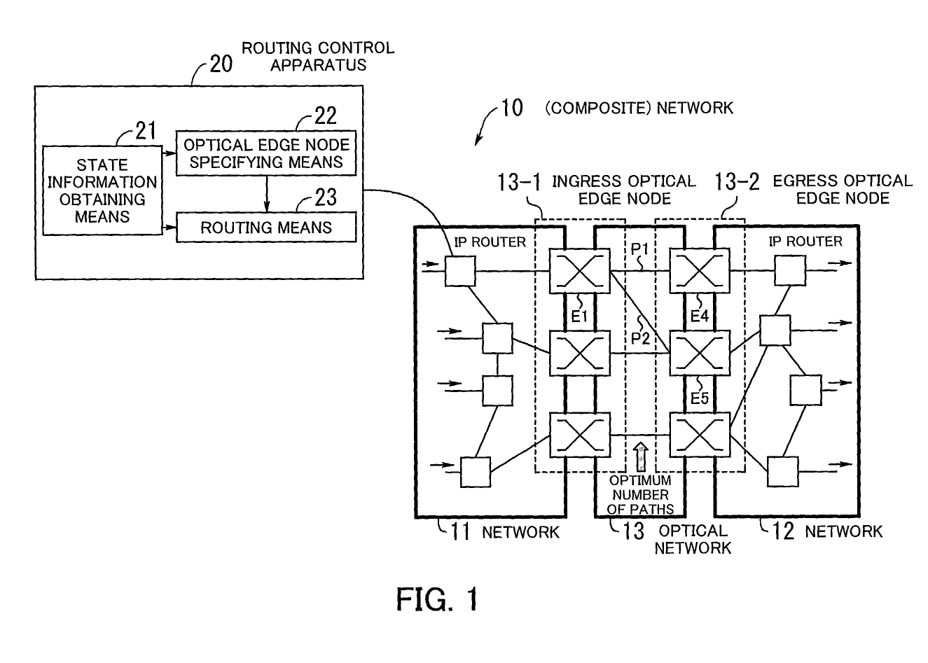

Embodiments of the present invention will now be described with reference to the drawings. FIG. 1 is a view for describing the principles underlying a routing control apparatus according to the present invention. A composite network 10 comprises networks 11 and 12 processing electrically and an optical network 13 processing optically. The network 11 and the optical network 13 connect via an ingress optical edge node 13-1. The network 12 and the optical network 13 connect via an egress optical edge node 13-2. The networks 11 and 12 include IP routers and a routing control apparatus 20 is connected to an IP router.

State information obtaining means 21 in the routing control apparatus 20 obtains state information regarding the composite network 10. State information obtained in the state information obtaining means 21 will be used by other means included in the routing control apparatus 20. This state information includes information regarding network topology, the functions of nodes, etc.

Optical edge node specifying means 22 specifies the egress optical edge node 13-2 located on the output side of the optical network 13 and the ingress optical edge node 13-1 located on the input side of the optical network 13 to establish an optical path to a destination address.

For example, if the optical edge node specifying means 22 specifies an egress optical edge node E4 and ingress optical edge node E1 shown in FIG. 1, an optical path P1 is established. If the optical edge node specifying means 22 specifies an egress optical edge node E5 and the ingress optical edge node E1 shown in FIG. 1, an optical path P2 is established.

Routing means 23 explicitly sets routes according to destinations to the ingress optical edge node 13-1 in the network 11 connected to the input side of the optical network 13. In this case, “explicit setting” means setting a route freely. The shortest route is not necessarily set.

As stated above, in the present invention, the ingress optical edge node 13-1 and egress optical edge node 13-2 in the optical network 13 are specified and a route to the ingress optical edge node 13-1 in the network 11 is explicitly set. This will enable to set a proper number of optical paths without connecting the ingress optical edge node 13-1 and egress optical edge node 13-2 in the full mesh form.

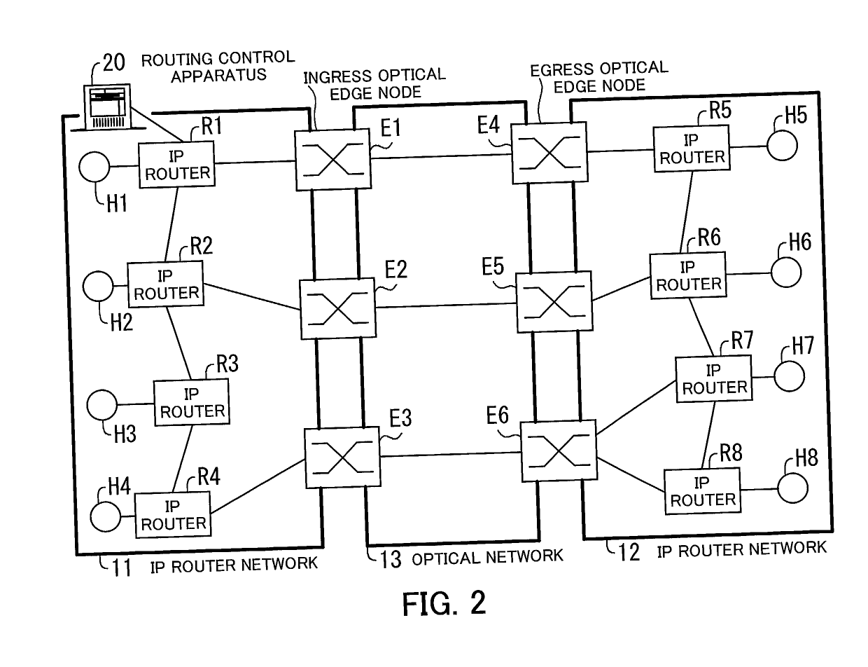

Operation (a first embodiment of the present invention) will now be described in detail. FIG. 2 is a view showing the structure of the first embodiment.

It is assumed that there is a composite network including the IP router networks 11 and 12 and optical network 13. The IP router network 11 and the optical network 13 connect via ingress optical edge nodes E1 through E3. The IP router network 12 and the optical network 13 connect via egress optical edge nodes E4 through E6.

The IP router network 11 includes IP routers R1 through R4, communication host terminals (hosts) H1 through H4, and the routing control apparatus 20. The IP routers R1 through R4 are connected in series and are connected to the hosts H1 through H4 respectively. Furthermore, the IP router R1 and ingress optical edge node E1 connect, the IP router R2 and ingress optical edge node E2 connect, and the IP router R4 and ingress optical edge node E3 connect. The routing control apparatus 20 connects with the IP router R1.

The IP router network 12 includes IP routers R5 through R8 and hosts H5 through H8. The IP routers R5 through R8 are connected in series and are connected to the hosts H5 through H8 respectively. Furthermore, the IP router R5 and egress optical edge node E4 connect, the IP router R6 and egress optical edge node E5 connect, and the IP routers R7 and R8 and egress optical edge node E6 connect.

The optical edge nodes E1 through E6 can communicate directly with one another at the optical level via an optical cross connector. In that case, one wavelength is needed for communication between each pair of optical edge nodes.

The IP router networks 11 and 12 include the hosts H1 through H4 and hosts H5 through H8 respectively. However, a destination is not limited to one of them. A destination can be a network which can be represented as a network address. When a network address is used, a plurality of hosts can be represented as one address, resulting in a simple destination representation.

The optical edge nodes E1 through E6 specified by the routing control apparatus 20 have the function of setting an optical path automatically. This function may belong to the optical edge nodes or may be performed by a unit which manages the optical network 13.

Now, procedures for operation to minimize the number of wavelengths in the optical network 13 in the case of controlling routing for communication from the IP router network 11 to the IP router network 12 will be described.

Setting by the routing control apparatus 20 will be performed when a network begins to function or when the state of a network changes by, for example, an increase or decrease in destination addresses.

The shortest communication routes from the egress optical edge nodes E4 through E6 to each of the hosts H5 through H8 are calculated by the optical edge node specifying means 22. In this case, the optical edge node specifying means 22 uses a shortest route calculating algorithm (Dijkstra, for example) on the basis of topology information regarding the IP router network 12 held by the state information obtaining means 21.

That is to say, in this example, communication is performed from the egress optical edge node E4 to the host H5 via the IP router R5, from the egress optical edge node E5 to the host H6 via the IP router R6, and from the egress optical edge node E6 to the host H7 via the IP router R7 and to the host H8 via the IP router R8.

The routing control apparatus 20 saves the correspondence between the destination hosts and egress optical edge nodes. The same results will be obtained by using a conventional routing protocol, such as RIP or OSPF. Therefore, if the above setting by the routing control apparatus 20 results in a considerable control delay or processing load, a conventional technique may be used.

At this point, the routing control apparatus 20 has specified the egress optical edge nodes E4 through E6 used to perform communication from the IP router network 11 to each of the hosts H5 through H8 in the IP router network 12.

Then the optical edge node specifying means 22 in the routing control apparatus 20 specifies the ingress optical edge nodes E1 through E3. In this case, it is assumed that the ingress optical edge nodes E1 through E3 are specified for the egress optical edge nodes E4 through E6 respectively.

And then wavelengths used to connect the ingress optical edge nodes and egress optical edge nodes are automatically set at the optical edge nodes. As a result, optical paths will be set between the ingress optical edge nodes and egress optical edge nodes. In the above example, the ingress optical edge nodes E1 through E3 and egress optical edge nodes E4 through E6 are specified so that optical paths will be established between them on a one-to-one basis.

Next, the routing means 23 explicitly sets routes to the ingress optical edge nodes E1 through E3 for traffic to the hosts H5 through HB in each of the IP routers R1 through R4 in the IP router network 11.

With communication from the host H4 to the host H5, for example, explicit routes in the IP routers R4, R3, R2, and R1 are set to “from IP router R4 to IP router R3,” “from IP router R3 to IP router R2,” “from IP router R2 to IP router R1,” and “from IP router R1 to ingress optical edge node E1,” respectively, by the routing means 23.

This information will be remotely set in an IP routing table stored in each router as a static entry by the use of, for example, the Telnet. This is the same with communication to the hosts H6, H7, or H8.

After these procedures are completed, only one path in the optical network 13 will be used according to a destination address regardless of where a source address exists. This enables to reduce the number of wavelengths used in the optical network 13.

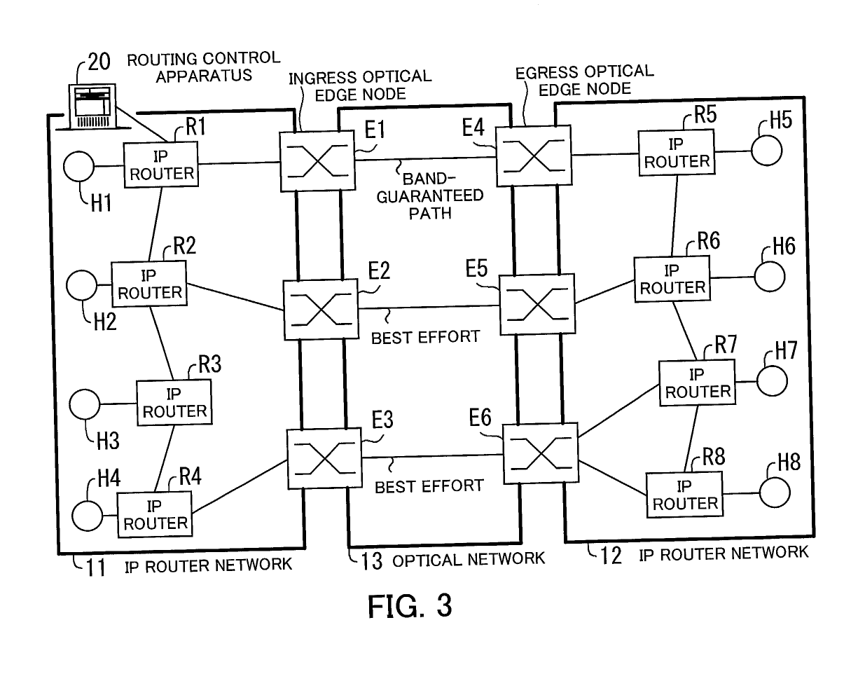

A second embodiment of the present invention will now be described. FIG. 3 is a view showing the structure of the second embodiment. The network structure and basic operation in the second embodiment are the same as those in the first embodiment, so its features will be chiefly described.

In this embodiment, it is assumed that the state information obtaining means 21 shows in advance that the optical edge nodes E1 and E4 can perform policing, shaping, and queue control to ensure a band.

It is assumed that two kinds of communication, that is to say, band-guaranteed communication and best effort communication are realized between the IP router networks 11 and 12. The egress optical edge node E4 has the function of ensuring a band. Therefore, it is distinguished from the other optical edge nodes and is treated as an optical edge node with routes to the hosts H5 through H8 used only for ensuring a band.

The egress optical edge nodes E5 and E6 are treated as optical edge nodes with routes to the hosts H5 through H8 for performing ordinary best effort communication. The optical edge node specifying means 22 recognizes these facts and specifies the egress optical edge nodes E4 through E6.

Then the optical edge node specifying means 22 specifies the ingress optical edge nodes E1 through E3. In this case, the optical edge node specifying means 22 specifies the ingress optical edge node E1 for the egress optical edge node E4 which can exercise control over the ensuring of quality, because the ingress optical edge node E1 has the same function as the egress optical edge node E4. Moreover, the optical edge node specifying means 22 specifies the ingress optical edge nodes E2 and E3 for the egress optical edge nodes E5 and E6, respectively, for best effort communication.

Next, the routing means 23 explicitly sets routes to the ingress optical edge nodes E1 through E3 for traffic to destination hosts in each of the IP routers R1 through R4 in the IP router network 11.

With best effort communication from the host H4 to the host H5, for example, explicit routes in the IP routers R4, R3, and R2 are set to “from IP router R4 to IP router R3,” “from IP router R3 to IP router R2,” and “from IP router R2 to ingress optical edge node E2,” respectively, by the routing means 23.

With band-guaranteed communication from the host H4 to the host H5, explicit routes in the IP routers R4, R3, R2, and R1 are set to “from IP router R4 to IP router R3,” “from IP router R3 to IP router R2,” “from IP router R2 to IP router R1,” and “from IP router R1 to ingress optical edge node E1,” respectively, by the routing means 23. This is the same with communication to the hosts H6, H7, or H8. As stated above, by using an optical path suitable for communication quality, the efficiency of network operation can be improved.

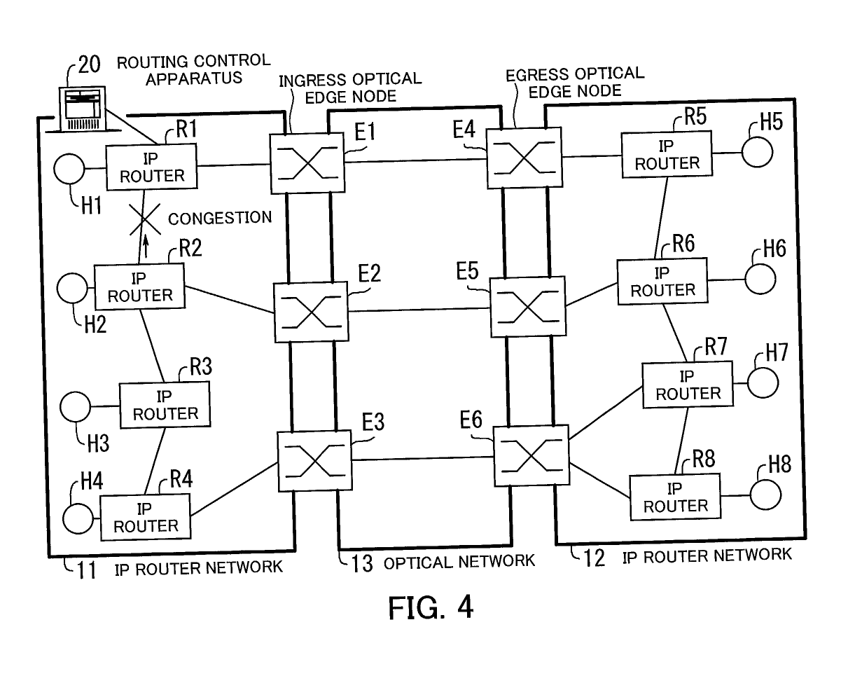

A third embodiment of the present invention will now be described. FIG. 4 is a view showing the structure of the third embodiment. The network structure and basic operation in the third embodiment are the same as those in the first embodiment, so its features will be chiefly described.

It is assumed that routing control, for example, described in the first embodiment has already been performed. Furthermore, it is assumed that the state information obtaining means 21 realizes that traffic from the IP router R2 to the IP router R1 on a link between them is heavy and that the usage of the link is high.

In this case, the state information obtaining means 21 may monitor IP routers periodically by the use of, for example, the simple network management protocol (SNMP) or an IP router may spontaneously inform the routing control apparatus 20 that the usage of a link has reached a certain value.

In addition, it is assumed that with communication from the host H4 to the host H5, for example, explicit routes in the IP routers R4, R3, R2, and R1 have already been set to “from IP router R4 to IP router R3,” “from IP router R3 to IP router R2,” “from IP router R2 to IP router R1,” and “from IP router R1 to ingress optical edge node E1,” respectively, by the routing means 23.

It is assumed that this information has been registered with a database in the routing control apparatus 20. The routing means 23 realizes from information registered with the database that all of the traffic to the host H5 goes through the ingress optical edge node E1, so it can predict that the link from the IP router R2 to the IP router R1 will be crowded (congested).

On the basis of this information, the routing means 23 changes the explicit route for traffic to the host H5 set in the IP router R2 from “from IP router R2 to IP router R1” to “from IP router R2 to ingress optical edge node E2.”

To make this change, a static entry regarding traffic to the host H5 in an IP routing table registered with the IP router R2 is removed and then the ingress optical edge node E1 is registered again as the next hop for traffic to the host H5.

In this example, only one explicit route is set for traffic from the IP router R2 to the IP router R1, but a plurality of explicit routes can be set. In that case, part of them may be changed or all of them may be changed.

Alternatively, if the congestion state of the link from the IP router R2 to the IP router R1 is monitored according to destination packets, the routing means 23 can change only an explicit route to a destination traffic to which has caused congestion.

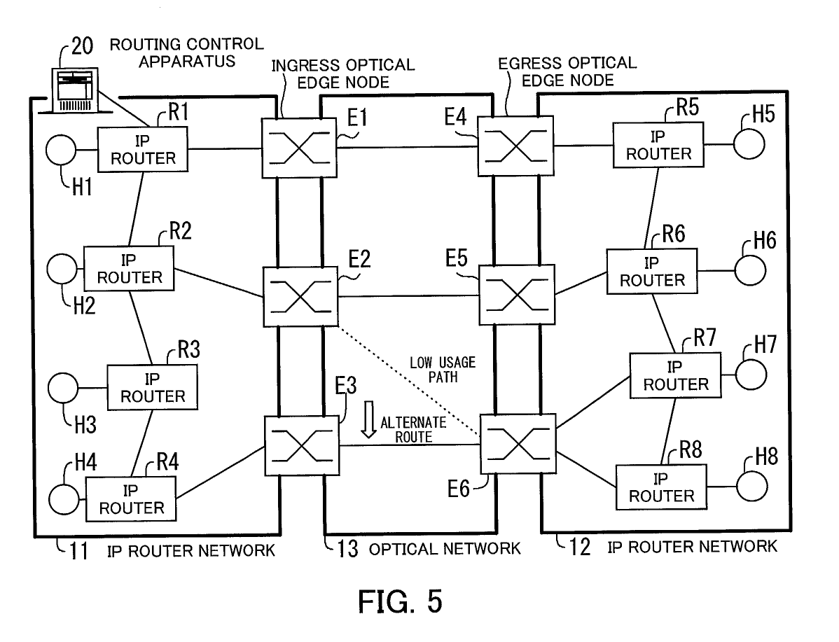

A fourth embodiment of the present invention will now be described. FIG. 5 is a view showing the structure of the fourth embodiment. The network structure in the fourth embodiment differs from that in the first embodiment, shown in FIG. 2, in that an optical path exists between the ingress optical edge node E2 and egress optical edge node E6. Except for this, the network structure and basic operation in the fourth embodiment are the same as those in the first embodiment.

It is assumed that the usage of a link from the ingress optical edge node E2 to the egress optical edge node E6 is 1% (low). The state information obtaining means 21 can obtain the usage of this link by monitoring that of the ingress optical edge node E2 by the use of, for example, SNMP.

The usage of this link is low, so the routing control apparatus 20 judges that it may cause traffic which uses this link to follow an alternate route. As a result, the routing control apparatus 20 causes traffic which flows into the egress optical edge node E6 from the ingress optical edge node E2 to follow the route, for example, from the ingress optical edge node E3 to the egress optical edge node E6 by explicit routing control.

The state information obtaining means 21 realizes that traffic uses the optical path from the ingress optical edge node E2 to the egress optical edge node E6 to reach the host H7 or H8 via the IP router R2 by the shortest route.

On the basis of this result, the optical edge node specifying means 22 cancels the specification instructions which were issued to establish the optical path from the ingress optical edge node E2 to the egress optical edge node E6. Moreover, the routing means 23 exercises explicit routing control over the IP routers R2, R3, and R4 so that traffic to the host H7 or H8 will use an optical path from the ingress optical edge node E3 to the egress optical edge node E6. By doing so, all the traffic will follow alternate routes.

As a result of the routing control, no traffic flows along the optical path between the optical edge nodes the specification instructions on which were canceled, so eventually the optical path will be removed.

As described above, the routing control apparatus 20 according to the present invention enables to reduce the number of wavelengths used at optical edge nodes, resulting in efficient network operation and a reduction of the cost of building a network.

Furthermore, destinations or communication quality can be controlled according to optical edge nodes, so the function of identifying many packets or labels will become unnecessary. This enables to simplify the structure of an optical edge node.

The routing control apparatus 20 described above is a theoretical function, so it can be implemented as a component of a physical device, such as an IP router node, label switch node, optical edge node, or policy server.

As described above, routing control was exercised over an IP router. However, explicit routing can be performed on a label switch router (LSR), being a label switch node used in an MPLS network, by the use of a protocol, such as CR-LDP or RSVP. This will save the procedure by the routing control apparatus 20 of setting routes for all of the nodes on a route, resulting in a simpler setting function in comparison to setting in an IP router.

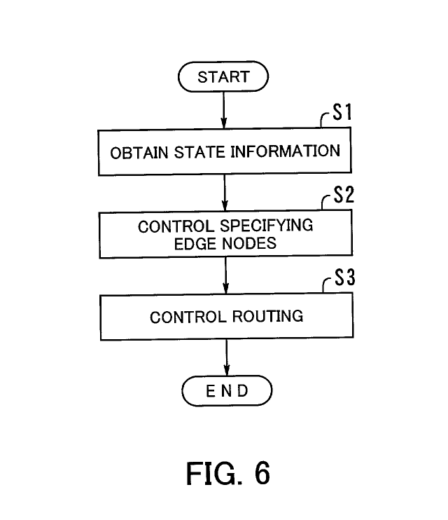

A routing control method according to the present invention will now be described. FIG. 6 is a flow chart showing a routing control method according to the present invention.

[S1] State information regarding a network is obtained.

[S2] In order to establish a path to a destination address, an egress edge node located on the output side of a core network and an ingress edge node located on the input side of the core network are specified. The egress edge node specified should give the shortest route to the destination address.

The specified ingress edge node and egress edge node automatically establish a path (connection) between them.

[S3] Routes according to destinations to the ingress edge node in an edge network connected to the input side of the core network are explicitly set on the basis of the state of a link.

An egress edge node and ingress edge node can be specified so that a label will be assigned to a path according to communication quality. Furthermore, if a path established by specifying an egress edge node and ingress edge node is judged because of low usage to be redundant, the specification instructions issued to set the path are canceled to open the path.

As stated above, a routing control method according to the present invention can establish not only an optical path in an optical network but also a proper number of paths (connections) between edge nodes in an electrical core network, resulting in less space for labels for these paths.

As has been described in the foregoing, a routing control apparatus according to the present invention specifies an ingress optical edge node and egress optical edge node in an optical network and explicitly sets a route to the ingress optical edge node in a network connected to the entry side of the optical network. This enables to set a proper number of optical paths without connecting ingress optical edge nodes and egress optical edge nodes in the full mesh form, resulting in efficient network operation.

Moreover, a routing control method according to the present invention specifies an ingress edge node and egress edge node in a core network and explicitly sets a route to the ingress edge node in an edge network connected to the entry side of the core network. This enables to set a proper number of paths without connecting ingress edge nodes and egress edge nodes in the full mesh form, resulting in efficient network operation.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A routing control apparatus for controlling routing in a network including an optical network, the apparatus comprising:
state information obtaining means for obtaining state information regarding the network;
optical edge node specifying means for specifying an egress optical edge node located on the output side of the optical network and an ingress optical edge node located on the input side of the optical network to establish an optical path to a destination address; and
routing means for setting explicitly routes according to destinations to the ingress optical edge node in a network connected to the input side of the optical network.

2. The routing control apparatus according to claim 1, wherein the optical edge node specifying means specifies the egress optical edge node which gives the shortest route to the destination address.

3. The routing control apparatus according to claim 1, wherein the optical edge node specifying means specifies the egress optical edge node and the ingress optical edge node so that a wavelength will be assigned according to communication quality.

4. The routing control apparatus according to claim 1, wherein the routing means explicitly sets a route on the basis of the state of a link in the network connected to the entry side of the optical network.

5. The routing control apparatus according to claim 1, wherein if an optical path established by specifying the egress optical edge node and the ingress optical edge node is judged because of low usage to be redundant, the optical edge node specifying means cancels specification instructions issued to set the optical path and opens the optical path.

6. A routing control method for controlling routing, the method comprising the steps of:
obtaining state information regarding a network;
specifying an egress edge node located on the output side of a core network and an ingress edge node located on the input side of the core network to establish a path to a destination address; and
setting explicitly routes according to destinations to the ingress edge node in an edge network connected to the input side of the core network.

7. The routing control method according to claim 6, wherein the egress edge node which gives the shortest route to the destination address is specified.

8. The routing control method according to claim 6, wherein the egress edge node and the ingress edge node are specified so that a label will be assigned to a path according to communication quality.

9. The routing control method according to claim 6, wherein a route is explicitly set on the basis of the state of a link in the edge network.

10. The routing control method according to claim 6, wherein if a path established by specifying the egress edge node and the ingress edge node is judged because of low usage to be redundant, specification instructions issued to set the path are canceled and the path is opened.
